(19) United States
(12) Patent Application Publication
(10) Pub. No.: US 2006/0185127 A1
(43) Pub. Date: Aug. 24, 2006

(54) Novel grip for writing instruments

(76) Inventors: William T. Geddes, Cockeysville, MD (US); Jiwei Gao, Shangai (CN)

Correspondence Address: STERNE, KESSLER, GOLDSTEIN & FOX PLLC, 1100 NEW YORK AVENUE, N.W., WASHINGTON, DC, 20005, US

(21) Appl. No.: 11/063,820

(22) Filed: Feb. 23, 2005

(51) Int. Cl. B25G 1/10; A47J 45/00

(52) U.S. Cl. 16/430

(57) ABSTRACT

A writing instrument grip of a particular form and material is described. The spirographic grip conforms independently to both the instrument and the instrument user.

### FIELD OF INVENTION

The present invention relates to grip means for writing instruments. More particularly, the present invention relates to a flexible spirographic grip for writing instruments, the grip having been made of flexible soft thermoplastic rubber (TPR) or of materials having similar properties, such as plastics or rubber. The grip provides cushion by conforming to the pressure-touch of the user's fingers and regains its original form when the pressure is removed.

### BACKGROUND OF INVENTION

Presently, grips are categorized as a writing instrument accessory for secure holding of the writing instrument, alleviating repetitive motion stress, fatigue or cramping of the fingers and the hand, assisting in the instruction of proper finger placement for handwriting, or in assisting developmental needs by accommodating physical deformities, temporary abnormalities, injury rehabilitation and the like. However, such grips being made of simple molded shapes lose their effectiveness because they stretch to conform to larger diameter writing instruments thereby causing the surface area to expand, which negates the cushioning effect.

Therefore, there is a need to provide grip means of such shapes and designs, which do not lose cushioning effective as they conform to larger diameter writing instruments and to the fingers of the user.

### SUMMARY OF INVENTION

It is, therefore, an object of the present invention to provide a writing instrument grip with exterior design qualities independent of the interior barrel channel of the grip to better retain flexibility, durability, strength, form, and function. Through the use of specific shapes and application of stacked repeating design elements, the resulting unitary grip exterior accentuates desired cushioning qualities and provides additional protection to the interior core.

It is another object of the invention to retain an exterior shape useful for the purpose of assisting writing-development skills in children and assisting rehabilitative services in persons with temporary or permanent disabilities of the hand.

It is yet another object of the invention to alleviate or prevent repetitive motion stress, fatigue, cramp or discomfort of the fingers and hand, which may occur after prolonged usage of the writing instrument without the grip accessory. In practice and application, the stacked spirographic designs conform and respond, naturally and by design, to the shape, position and movement of the user's fingers.

### BRIEF DESCRIPTION OF THE DRAWINGS

The above and various other objectives and advantages of the present invention will be better understood by reference to the accompanying drawings which are only illustrative and not limiting of the embodiments of the invention.

FIG. 1 illustrates the rectangular spirographic grip in top and side views and in 2D rendition.

FIG. 2 illustrates the circular spirographic grip in top and side views and in 2D rendition.

FIG. 3 illustrates the star shaped spirographic grip in top and side views and in 2D rendition.

### DETAILED DESCRIPTION OF THE INVENTION

The invention comprises a writing instrument grip of soft thermoplastic material, such as plastics or rubber. The thermoplastic material is of such nature and properties that it can stretch and conform to writing instruments of varying sizes while specifically retaining full cushioning comfort due to the stacked spirographic geometric designs including, but not limited to, hypocycloids, epicycloids or trochoids extrusions of repeating elements. The grip has an open ended interior barrel chamber, which stretches to the diameter of the writing instrument while the exterior unitary spirographic geometric design retains its original shape independently of the interior chamber. The inherent properties of the particular TPR material used for the grip provide strength, durability, flexibility, and resistance to deformation. The illustrated embodiments provide an additional measure of protection from abrasion and tearing to the interior core, as well as retention of the exterior form necessary to alleviate or prevent repetitive motion distress, rehabilitate writing skills in persons with temporary or permanent disabilities of the hand, and assist in the development of writing skills in novice handwriters.

It should be understood that unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the methods and materials described herein are preferred. Unless mentioned otherwise, the techniques employed or contemplated herein are standard methodologies well known to one of ordinary skill in the art. The materials, methods and examples are only exemplary and not limiting.

The term “spirographic” as used herein means that the grip has a spiral configuration.

The grip of the present invention comprises an open interior barrel chamber of about 8 mm diameter, which stretches to the diameter of writing instrument of varying diameters and allows the writing end of the writing instrument to pass through while the exterior TPR spirographic stacked elements provide a comfortable grip of the writing instrument. The spirographic stacked elements form a unitary whole, each stacked element being of about 2 cm diameter, which retains its original shape independently of the interior chamber while also conforming to the shape, position and slight movements of a user's fingers while writing. The total length of the grip is about 4 cm. The spirographic elements regain their original shape and contour when the finger pressure is withdrawn.

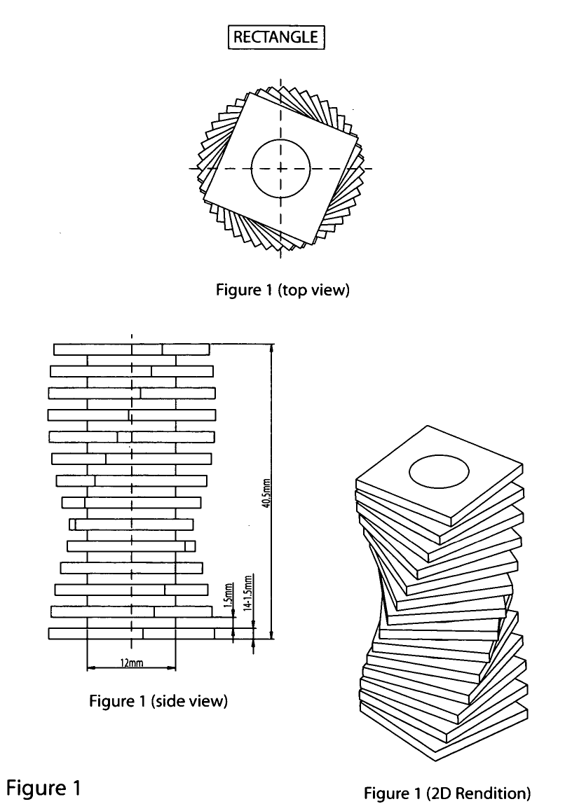

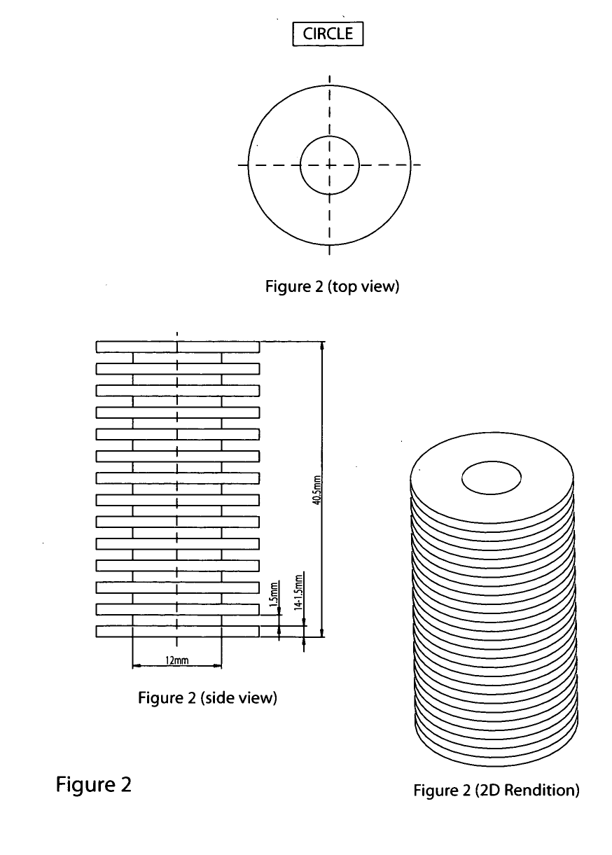

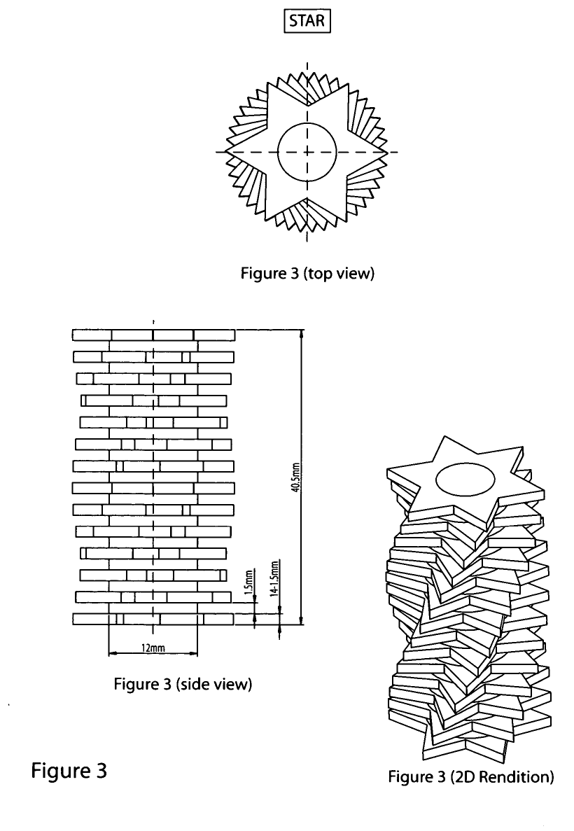

The three designs of spiraling cylindrical shapes: stars, circles, and rectangles illustrated in top view in FIGS. 1-3 may be made of elements of the same or of assorted different colors. Each element is stacked upon the other, with each successive element rotated at consistent degrees off the preceding element. Degree of rotation varies according to the desired specific shape and design.

Each grip is “open-ended,” referring to openings on either end of the spirographic cylindrical shape for the purpose of inserting therethrough a writing instrument—a pen, pencil, mechanical pencil, marker, highlighter, multiple point pencil, crayon, and the like. Interior core can be stretched over writing instruments of varying diameter.

Example embodiments of the present invention have now been described in accordance with the above advantages. It will be appreciated that these examples are merely illustrative of the invention and not limitations thereof. Many variations and modifications will be apparent to those skilled in the art and all such modifications and variations are included within the purview and scope of the appended claims.

1. A writing instrument grip, comprising an open ended barrel of flexible soft thermoplastic material that adjusts and conforms to writing instruments of varying sizes while retaining and providing cushioning comfort to the fingers of a user, said grip being of stacked spirographic geometric design of repeating elements forming a unitary whole.

2. The grip of claim 1, wherein the open end of the barrel has a star, rectangle or a circle shape.

3. The grip of claim 2, wherein the stacked spirographic geometric design includes hypocycloids, epicycloids or trochoids extrusions of repeating elements.

4. The grip of claim 3, wherein each repeating element is stacked upon the other, with each successive element rotated at a consistent degree off the preceding element, the degree of rotation varying according to a specific design.

5. The grip of claim 4, wherein the elements are of the same or different color.

6. The grip of claim 5, wherein the soft thermoplastic material is plastics or rubber.

7. The grip of claim 6, wherein the barrel has openings on the top and bottom ends of the barrel for insertion therethrough of a writing instrument, said grip reverting to its original configuration when the writing instrument is removed.
